(19) United States
(12) Patent Application Publication
(10) Pub. No.: US 2002/0093908 A1
(43) Pub. Date: Jul. 18, 2002

(54) Noise/interference suppression system

(75) Inventor: Tet Hin Yeap, Ottawa (CA)

Correspondence Address: Adams Cassan Maclean, P.O. Box 11100, Station H, Ottawa, ON, K2H 7T8, CA

(73) Assignee: Esion Networks Inc.

(21) Appl. No.: 09/988,266

(22) Filed: Nov. 19, 2001

Related U.S. Application Data
(60) Provisional application No. 60/252,923, filed on Nov. 27, 2000.

(30) Foreign Application Priority Data
Nov. 24, 2000 (CA) 2,326,948

(51) Int. Cl. H04J 1/12; H04J 15/00

(52) U.S. Cl. 370/201

(57) ABSTRACT

A noise suppression circuit for a communications channel (12) comprises a noise reference extraction device (14), for example a hybrid transformer or circuit, for extracting from an input signal (S) a reference signal (N_{CM}) corresponding to a noise component in the input signal and supplying the noise reference signal to a noise estimation unit (16) which derives therefrom a noise estimate (Yⱼ) which is subtracted from the input signal to produce a noise-suppressed output signal (D_{OUT}). The noise suppression circuit comprises a first analog-to-digital converter (24) for digitizing the input signal at a first sampling rate (Fs) and a second analog-to-digital converter for sampling the noise reference signal (N_{CM}) at a second, lower sampling rate (FS/M), the ratio (M) between the two sampling rates being an integer. A decimator (40) decimates the input signal to produce a decimated signal (Dⱼ+Nⱼ). An adaptive filter (34) produces a noise estimate signal (Y′ⱼ) that is subtracted from the decimated signal to produce an error signal (εⱼ) which is used by adaptive filter (34) to adjust its coefficients. An interpolator (36) interpolates the interim noise estimate signal (Y′ⱼ) by the same integer (M) to provide a noise estimate signal (Yⱼ) which is subtracted from a digitized and delayed version of the input signal to produce the noise-suppressed output signal (D_{OUT}).

This application claims priority from U.S. Provisional patent application No. 60//252,923 filed Nov. 27, 2000 and Canadian patent application No. 2,326,948 filed Nov. 24, 2000.

### DESCRIPTION

1. Technical Field

This invention relates to a method and apparatus for reducing interference in signals, especially signals in communications channels, and is especially, but not exclusively, applicable to the suppression of common mode noise, such as radio frequency interference (RPI) typically caused by imbalance in so-called digital subscriber loops of telephone systems.

2. Background Art

A digital subscriber loop comprising a twisted wire pair carries both differential and common mode currents induced by the signal and noise sources, respectively. Common mode noise can be conveniently categorized into (i) impulse noise, (ii) radio frequency interference (RFI), and (iii) crosstalk. When telephone subscriber loops operated at relatively low frequencies, perhaps 3,000 Hz. or 4,000 Hz., the use of twisted wire and hybrid transformers helped to cancel out any induced interference. In a perfectly balanced loop, the common mode currents will not interfere with the differential current (information signal). However, when bridge taps, poorly twisted cable, and so on, cause the circuit to be unbalanced, longitudinal current injected by external noise sources will be converted into differential current at the receiver and detected as noise. Such noise can lead to errors by introducing jitter in timing extraction circuits or by causing false pulse detection.

There is a trend towards higher bit rates in so-called digital subscriber loops (DSL). With the introduction of ADSL (Asymmetric Digital Subscriber Loops) and VDSL (Very high speed Digital Subscriber Loops), the frequency of operation is approaching the radio frequency bands used by commercial AM radio stations transmitting in the vicinity on certain frequencies with a relatively narrow bandwidth. As a result, balancing of the cable is no longer sufficient to reduce the RFI sufficiently.

Various techniques are known for reducing interference or noise in a signal. U.S. Pat. No. 4,238,746 (McCool et al., U.S. Pat. No. 4,995,104 (Gitlin) and U.S. Pat. No. 5,903,819 (Romesburg) are examples of the many patents disclosing noise suppression circuits.

McCool et al. disclose a noise suppression circuit which uses an adaptive filter to derive a noise estimate signal which is subtracted from the input signal to cancel the noise therein. The noise-cancelled signal is fed back to the adaptive filter via an amplifier and used to adjust its weighting coefficients so as to reduce mean square error,

A disadvantage of this arrangement is that it is computationally intensive and so not suitable for high frequency use.

Gitlin discloses a circuit for cancelling crosstalk noise due to coupling between pairs of a multi-pair telephone cable. The circuit requires a training process which entails transmitting a known or desired signal to the receiver. At the receiver, an estimate of the crosstalk signal is determined by subtracting the estimated known signal from a delayed version of a corrupt received signal. This estimate is then used to train an adaptive filter and an error signal is computed by subtracting the output of the adaptive filter from the corrupt received signal. The training of the filter is achieved by using the error and LMS algorithm. After training, the adaptive filter is then used as a crosstalk estimator, A disadvantage of this approach is that the crosstalk channel always changes with time, so frequent re-training of the adaptive filter is needed. It also is computationally intensive.

Romesburg discloses a circuit for suppressing periodic audio noise signals superimposed upon an information speech signal, such as noise in a radiotelephone signal caused by the running engine of a motor vehicle in or near which the radiotelephone is being used. The periodic noise cancellation entails detecting the periodic noise component portions of the received signal generated by a source of periodic interference; generating the corresponding periodic signal of the same frequency, amplitude and phase, forming an estimate of the noise component detected; and cancelling out the noise components from the corrupted information signal by subtracting the generated periodic signal from the speech signal. Romesburg's circuit is not entirely satisfactory because it is for periodic interference. It also is computationally intensive.

According to international patent application number PCT/US97/06381 published on Oct. 30, 1997, John Cioffi et al. proposed to cancel noise in a communications signal by means of an adaptive wide band filter which is tuned by a reference signal when there are quiet periods in the received signal. This is not entirely satisfactory because it involves timing to ensure that the quiet periods are detected. Moreover, because noise patterns may change, the filter must be tuned frequently, which increases overhead and so reduces transmission efficiency.

An object of the present invention is to eliminate or at least mitigate the disadvantages of the foregoing known techniques.

### DISCLOSURE OF INVENTION

According to one aspect of the present invention, there is provided noise suppression apparatus comprising means for deriving a reference noise signal representing noise in a selected portion of a frequency spectrum of an input signal, first analog-to-digital conversion means for sampling the input signal at a first sampling frequency (Fₛ) to produce a digital signal, second analog-to-digital conversion means for sampling the reference noise signal at a lower sampling frequency (Fₛ/M) to provide a digital reference noise signal having a sample rate lower than a sample rate of the digital signal, decimation means for decimating the digital signal to produce a decimated signal having the same sample rate as the digital reference noise signal, adaptive filter means having adjustable coefficients for filtering the digital reference noise signal to provide a noise estimate signal, means for subtracting the noise estimate signal from the decimated signal to provide an error signal, the adaptive filter means using the error signal to adjust the coefficients of the adaptive filter, interpolation means for upsampling and interpolating the noise estimate signal to restore the noise estimate signal to the same sample rate as the digital signal, means for subtracting the restored noise estimate signal from the digital signal to provide a noise-suppressed output signal, and delay means for synchronizing the digital signal and the restored noise estimate signal as applied to the second subtracting means.

According to a second aspect of the invention, a method of suppressing noise in an input signal comprises the steps of deriving a reference noise signal representing noise in a selected portion of a frequency spectrum of the input signal, converting the input signal to a digital signal by sampling the input signal at a first sampling frequency (Fₛ), sampling the reference noise signal at a lower sampling frequency (Fₛ/M) to provide a digital reference noise signal that has a sample rate lower than a sample rate of the digital signal, decimating the digital signal to produce a decimated signal having the same sample rate as the digital reference noise signal, using an adaptive filter means having adjustable coefficients, filtering the digital reference noise signal to provide a noise estimate signal, subtracting the noise estimate signal from the decimated signal to provide an error signal, using the error signal to adjust the coefficients of the adaptive filter, upsampling and interpolating the noise estimate signal to restore the noise estimate signal to the same sample rate as the digital signal, synchronizing the digital signal and the restored noise estimate signal and subtracting the restored noise estimate signal from the digital signal to provide a noise-suppressed output signal.

According to a third aspect of the invention, there is provided noise suppression apparatus comprising:

means (14) for deriving a reference noise signal (N_{CM}) representing noise in a selected portion of a frequency spectrum of an input signal (S),

first analog-to-digital conversion means (24) for sampling the input signal at a first sampling rate (Fₛ) to produce a digital signal (Dⱼ+Nⱼ),

second analog-to-digital conversion means (32) for sampling the reference noise signal (N_{CM}) at a lower sampling frequency (Fₛ/M) to provide a digital reference noise signal (Xⱼ) having a symbol rate lower than a symbol rate of the digital signal,

interpolation means (46) for upsampling and interpolating the noise digital reference signal (Y′ⱼ) to the same rate as the digital signal (D′ⱼ+N′ⱼ),

adaptive filter means (34) having adjustable coefficients (W) for filtering the interpolated digital reference noise signal (Xⱼ′) to provide a noise estimate signal (Yⱼ′), and

means (18) for subtracting the restored noise estimate signal (Yⱼ) from the digital signal (Dⱼ+Nⱼ) to provide a noise-suppressed output signal (D_{OUT}),

the noise-suppressed output signal (D_{OUT}) being supplied to the adaptive filter for use in updating weighting coefficients thereof.

According to a fourth aspect of the invention, there is provided a method of suppressing noise in an input signal comprising the steps of:

(i) deriving a reference noise signal representing noise in a selected portion of a frequency spectrum of the input signal,

(ii) converting the input signal to a digital signal by sampling the input signal at a first sampling rate (Fₛ),

(iii) sampling the reference noise signal at a lower sampling frequency (Fₛ/M) to provide a digital reference noise signal that has a symbol rate lower than a symbol rate of the digital signal,

(iv) upsampling and interpolating the noise estimate signal to the same sampling rate as the digital signal,

(v) using an adaptive filter means having adjustable coefficients to filter the interpolated digital reference noise signal to provide a noise estimate signal,

(vi) subtracting the noise estimate signal from the decimated signal to provide a noise-suppressed signal, and

(vii) using the noise-suppressed signal to adjust the coefficients of the adaptive filter.

Embodiments of any of the foregoing aspects of the invention may be used to suppress noise in communications signals in telephone subscriber loops, in which case the portion of the frequency spectrum may embrace frequencies used by neighbouring commercial AM radio stations.

### BRIEF DESCRIPTION OF THE DRAWINGS

Embodiments of the invention will now be described by way of example only and with reference to the accompanying drawings in which:

FIG. 1 is a simplified schematic block diagram of a noise suppression circuit according to a first embodiment of the present invention;

FIG. 2 is a detailed schematic diagram of an adaptive filter of the circuit of FIG. 1;

FIG. 3 is a detailed schematic block diagram of a coefficient tuning unit of the adaptive filter;

FIG. 4 is a detailed schematic block diagram of one of a plurality of weighting coefficient tuning devices of the adaptive filter; and

FIG. 5 is a simplified schematic diagram of a second embodiment of the invention.

### BEST MODE(S) FOR CARRYING OUT THE INVENTION

In the drawings, identical or corresponding components in the different Figures have the same reference numbers.

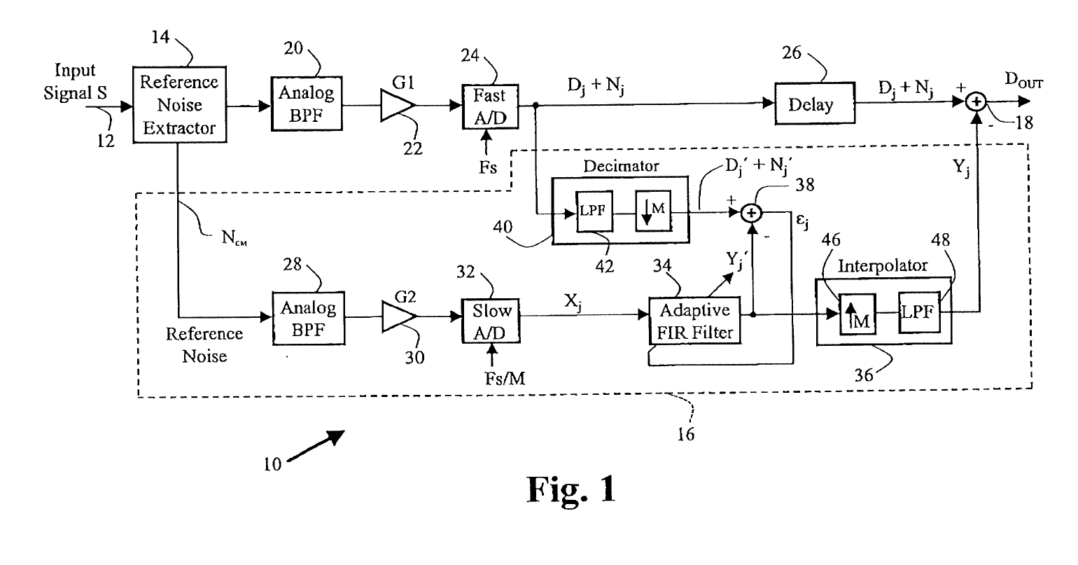

In FIG. 1, a noise suppression circuit 10 portion of a receiver is shown connected to a communications channel 12 by way of a noise reference signal extraction circuit 14. Where the communications channel 12 is, for example, a twisted-pair subscriber loop, the noise reference extraction circuit 14 might be a hybrid transformer having a centre-tapped primary winding connected to the TIP and RING of the twisted pair and the tap providing the reference noise signal. In addition to the received information signal, the input signal S comprises common mode noise, specifically radio frequency interference injected into the communications channel 12 as a common mode signal which is converted into differential mode current and detected as noise by the receiver. Typically, in a subscriber loop, the radio frequency signals are from commercial AM radio stations and within the frequency band from about 550 kHz. to about 1.6 MHz.

The noise reference extractor 14 extracts the common mode noise reference signal N_{CM} and supplies it to a noise estimator circuit 16 which produces a digital noise estimate signal Yⱼ that is substantially phase-inverted and supplies it to one input of a first summer 18. The differential signal D+N containing the common mode noise component is filtered by an analog bandpass filter 20, anplified by a gain control amplifier 22 and digitized by a “fast” analog-to-digital converter 24. The A-D converter supplies the digitized differential signal Dⱼ+Nⱼ by way of a delay unit 26 to the summer 18, which subtracts the noise estimate signal Yⱼ from it and supplies the resulting “noise-reduced” differential signal D_{OUT} as the “output signal” to the usual signal processing sections of the receiver (not shown in FIG. 1),

Bandpass filter 20 has a passband from about 135 kHz. to about 12 Mhz. and so removes both low frequency signals, such as the usual (POTS) telephone signals, from the differential signal, together with any high frequency interference above 12 MHz. The amplifier 22 adjusts the amplitude of the filtered differential signal to optimize the resolution of high speed analog-to-digital converter 24, which typically samples at a sampling rate that is several times the highest frequency of the data being transmitted on the subscriber loop. Delay unit 26 delays the differential signal by an amount sufficient to compensate for delay incurred by the common mode noise reference signal during processing by the noise estimator 16.

Within the noise estimator 16, the common mode reference noise signal N_{CM} is filtered by a second bandpass filter 28, has its amplitude adjusted by a second gain control amplifier 30 and is digitized by a second (slow) analog-to-digital converter 32 which supplies the digitized reference noise signal Xⱼ to an adaptive FIR filter 34. The amplifier 30 adjusts the amplitude of the reference noise signal N_{CM} to match it to the “slow” A-D converter 32. The bandwidth of the second bandpass filter 28 is from about 550 kHz. to about 1.6 MHz. so that it passes only those parts of the reference noise signal in the frequency bands in which most radio frequency noise will occur, typically from commercial AM radio stations. The second “slow” A-D converter 32 samples the reference noise signal N_{CM}, at a sampling rate that is a sub-multiple “M” of the sampling rate used by “fast” A-D converter 24, to provide a digitized noise reference signal Xⱼ. In a typical system, “M” might range from, say 4 to about 10. For VDSL up to 12 MHz., for example, the sampling rate Fs of the “fast” A-D converter 24 might be 40 MHz. and the sampling rate Fs/M of the “slow” A-D converter might be 10 MHz.

The adaptive FIR filter 34 filters the digitized reference noise signal Xⱼ to provide a slow rate noise estimate signal Yⱼ′ and supplies it to both an interpolator unit 36 and one input of a second summing device 38. A decimator 40 coupled to the output of “fast” A-D converter 24 decimates the digitized differential signal Dⱼ+Nⱼ and supplies the decimated differential signal Dⱼ′+Nⱼ′ to the other input of the second summing device 38, which subtracts the “slow” noise estimate signal Yⱼ′ from the decimated differential signal Dⱼ′+Nⱼ′ to form a “slow” error signal εⱼ, The summing device 38 supplies the “slow” error signal εⱼ to the adaptive FIR filter 34 which uses it in adapting its weighting coefficients, as will be described later. The decimator 40 comprises a low pass anti-aliasing filter 42 and a downsampler 44 which downsamples the filtered digitized differential signal by a ratio equal to the sub-multiple M. Hence, the decimated differential signal Dⱼ′+Nⱼ′ and the slow noise estimate Yⱼ′ are at the same rate when subtracted by summing device 38. The interpolator unit 36 comprises an upsampler 46 which upsamples it at the rate M and a low pass filter 48 which removes redundant duplicates caused by the upsampling and supplies the resulting “fast” noise estimate signal Yⱼ to the first summing device 18 for subtraction from the digitized and delayed differential signal Dⱼ+Nⱼ to obtain the noise-suppressed output signal for output to the later stages of the receiver for data extraction in the usual way.

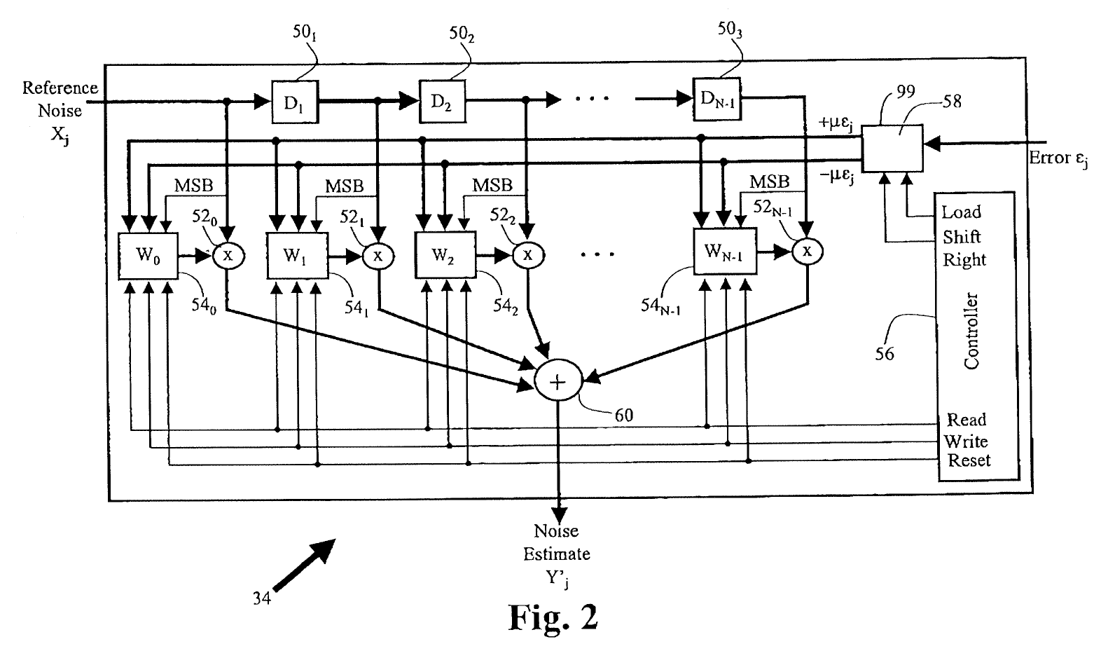

The adaptive filter unit 34 will now be described in more detail with reference to FIGS. 2, 3, 4 and 5. As shown in FIG. 2, the general configuration of the adaptive filter 34 is similar to that disclosed in U.S. Pat. No. 4,238,746. It comprises a series of N one-sample delay units 50₁, 502, . . . , 50_{N-1}, which form a tapped delay line, a plurality of multipliers 52₀, 52₁, 52₂, . . . , 52_{N-1} and a plurality of weighting coefficient tuning units 54₀, 54₁, 54₂, . . . , 54_{N-1}. Each tap between two adjacent delay units is coupled to a respective one of the multipliers and the final tap, i.e., the output of final delay 50_{N-1}, is supplied to the last multiplier 54_{N-1}. A control unit 56 provides clock signals to control the components of the adaptive filter unit 34 but, for clarity, the clock signal lines are not shown.

The reference noise signal samples N, from the “slow” A-D converter 32 are applied to the input of the first delay unit 50₁ and to the input of the first multiplier 52₀. The delayed samples at the outputs of the delay units 50₁, 50₂, . . . , 50_{N-1} are applied simultaneously to the inputs of the multipliers 52₀, 52₁, 52₂, . . . , 52_{N-1}, respectively. The adaptive filter 34 differs from that disclosed in U.S. Pat. No. 4,238,746 in that the most significant bit (MSB) of each sample also is supplied to the respective one of the weighting coefficient tuning units 54₀, 54₁, 54₂, . . . , 54_{N-1}, together with a pair of incremental error signals +μεⱼ and −μεⱼ having a small step size and derived from the error signal εⱼ by incremental error unit 58. The weighting coefficients W₀, W₁, W₂, . . . , W_{N-1}, respectively, are updated in each sampling period and supplied to the multipliers 52₀, 52₁, 52₂, . . . , 52_{N-1}, respectively, which use them to weight the corresponding signals from the tapped delay line, A summing device 60 sums the weighted symbols from the multipliers 52₀, 52₁, 52₂, . . . , 52_{N-1}, in each sample period, to form the “slow” noise estimate Y′ⱼ which is supplied to the interpolator 36 (FIG. 1).

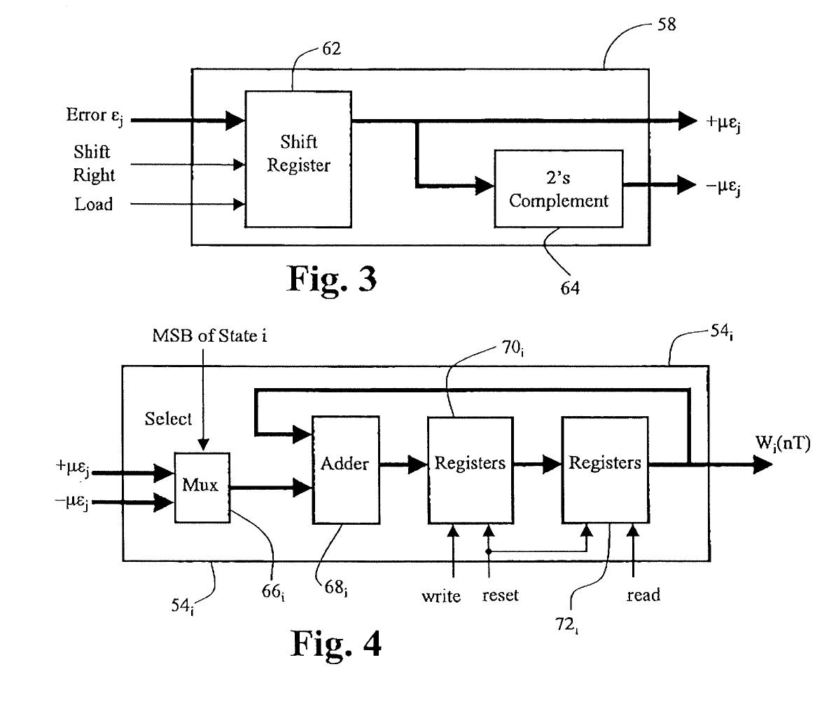

As shown in FIG. 3, the incremental error circuit 58 comprises a shift register 62 and a two's complement circuit 64. Typically, the error signal εⱼ and the incremental error signals +μεⱼ and −μεⱼ will have the same number of bits as the A-D converter 32, for example, 14 bits The “slow” error signal εⱼ is loaded into the shift register 62 under the control of a LOAD signal and then shifted RIGHT by one or more bits according to the desired step size by which the coefficient is to be adjusted. The actual step size will be determined empirically, e.g. by simulation. The LOAD and SHIFT-RIGHT signals are supplied by the control circuit 56 (FIG. 2). The output of the shift register 62 is the incremental error signal +με and is supplied to two's complement circuit 64 which uses it to generate the negative incremental error signal −με. Both of the incremental error signals +με and −με are supplied to each of the weighting coefficient tuning units 54₀, 54₁, 54₂, . . . , 54_{N-1}.

Each of the weighting coefficient tuning units 54₀, 54₁, 54₂, . . . , 54_{N-1} uses the most significant bit (MSB) from the corresponding delayed sample to toggle between the incremental error signals +μεⱼ and −μεⱼ. The weighting coefficient tuning units 54₀, 54₁, 54₂, . . . , 54_{N-1} are similar so only one of them, unit 54ᵢ, is shown in FIG. 4 and will now be described. Weighting coefficient tuning unit 54ᵢ comprises a selector unit 66ᵢ, conveniently a multiplexer, having two inputs to receive the incremental error signals +μεⱼ and −μεⱼ, respectively. The MSB of state i, the delayed signal for the corresponding tap of the adaptive filter unit 34, is applied to a SELECT input of the selector 66ᵢ and determines which of the incremental error signal samples is selected for output from the selector unit 66ᵢ to a first input of an adder 68ᵢ. The adder 68ᵢ adds the incremental error sample to the previous weighting coefficient Wᵢ((n−1)T), which is fed back from the output of the weighting coefficient tuning unit 54ᵢ, and supplies the sum, the updated weighting coefficient, to a first (master) D-type register 70ᵢ, which is controlled by WRITE signals from the controller 56 (FIG. 1) to clock the new weighting coefficient value into the master register 70ᵢ. A second (slave) register 72ᵢ which is controlled by a READ signal also from the controller 56, reads the contents of the master shift register 70ᵢ and supplies the same as the output of the weights-coefficient tuning value Wᵢ(nT) and also feeds it back to the adder 68ᵢ. The shift registers 70ᵢ and 72ᵢ can be reset, when operation commences, by means of a RESET signal from controller 56. Whether the value of the new weighting coefficient Wᵢ(nT) at the output of slave D-type register 72ᵢ is greater or less than the value of the previous weighting coefficient Wᵢ((n−1)T) will depend upon the particular one of the incremental error signals +μεⱼ and −μεⱼ selected by the selector 66ᵢ.

Operation of the adaptive filter 34 will now be described, beginning with a summary of the operation of a conventional adaptive filter of the transversal filter kind and concluding with an explanation of how the operation of the adaptive filter 34 differs from the conventional adaptive filter The input signal S comprises the attenuated and distorted information signal D and the induced noise N_{CM}. The common-mode signal N_{CM}, which is the reference noise for the system, is assumed to be uncorrelated with the information signal D. Following analog-to-digital conversion, the signals are digital, and j is a discrete-time index. The digital reference noise signal Xⱼ and the noise component Nⱼ in the digitized version of the input signal are correlated in some unknown manner, so the tap weights Wⱼ of the adaptive filter 34 can be adjusted such that the noise estimate Yⱼ which is obtained by upsampling and interpolating the filter's output Y′ⱼ. closely approximates Nⱼ. If this operation is performed correctly, the output signal D_{OUT} will contain much less noise than the originally received signal Dⱼ. It should be noted that, in FIG. 2, the primes in the symbols D′ and N′, etc. simply signify that they are at the lower sampling rate.

The simplest method of adjusting the adaptive filter weights is the widely used least-mean-square (LMS) algorithm, This iterative technique attempts to minimize the mean-squared error (MSE) between the desired response Dⱼ′ and the filter output Yⱼ′. When the filter input Xⱼ and the downsampled data signal Dⱼ′ are wide-sense stationary, and the filter has M taps, the MSE may be viewed as an M-dimensional “error-performance surface” with a uniquely defined minimum point. The tap weights which correspond to this minimum point give the optimum estimate of Nip which can be generated using Xⱼ; this is called the Wiener solution.

The LMS algorithm seeks out the minimum point of the error-performance surface by calculating a series of instantaneous error gradients; at each iteration, it assumes that εⱼ², the square of a single error sample, is an estimate of the mean-squared error. This approximation reduces system complexity, but means that the algorithm does not converge continually towards the minimum point. It follows a noisy path, occasionally steering in the wrong direction. Once it is close to the minimum point, it fluctuates about it but never converges to it exactly. For this reason, it is called a stochastic gradient algorithm, and one of its key limitations is the “gradient noise” caused by its random “walk” about the Wiener solution.

Defining the vectors for the common-mode input and the adaptive filter weights as:

$${X}_{j} ≡ \{ \begin{matrix}{x}_{j} \\ {x}_{j - 1} \\ ⋮ \\ {x}_{j - M + 1}\end{matrix} \} , \text{and} W ≡ \{ \begin{matrix}{w}_{1} \\ {w}_{2} \\ ⋮ \\ {w}_{M}\end{matrix} \} \qquad ( 3 )$$

the LMS algorithm at iteration j is described by the two equations:

εⱼ=dⱼ−Yⱼ=dⱼ−Wⱼ^{T}Xⱼ (4)

and

Wⱼ₊₁=Wⱼ+2μεⱼXⱼ (5)

where T denotes matrix transposition, and all matrix entries are assumed to be real. The parameter μ, i.e., the step size, controls the algorithm's stability and rate of convergence. A low μ reduces the undesirable gradient noise experienced at steady state, but slows down the algorithm's convergence. To guarantee convergence, μ preferably should satisfy the relation.

$$0 < μ < \frac{1}{{\sum }_{l = 0}^{M - 1} E \{ {\vert {x}_{j - 1} \vert}^{2} \}} \qquad ( 6 )$$

where E is the expectation operator, and the quantity in the denominator of the right-hand term is called the “tap-input power”. In general, an adaptive noise canceller can achieve near-perfect cancellation of a single narrowband interference source. If multiple interferers are present, the most powerful one will be almost perfectly cancelled but the remainder will be only partially suppressed. If all of the interferers have the same power spectral density (PSD) and uncorrelated coupling paths to the loop, as is likely in the case of crosstalk noise, almost no cancellation at all will be achieved.

In non-stationary environments, the LMS algorithm can reliably track the time-varying minimum point of the error-performance surface, provided that the input data statistics vary slowly compared to the learning rate of the system.

For further information about the LMS algorithm, the reader is directed to the afore-mentioned U.S. Pat. No. 4,238,746 and the following articles, all of which are incorporated by reference:

[1) “Adaptive Noise Cancelling: Principles and Applications” by Bernard Widrow et al., Proceedings of the IEEE, Vol, 63, No. 12, December 1975, pp. 1692-1716.

[2] “Limited-Precision Effects in Adaptive Filtering” by John M. Cioffi, IEEE Transactions on Circuits and Systems, Vol. CAS-34, No. 7, July 1987, pp. 821-833.

[3] “A Unified View: Efficient Lest Squares Adaptive Algorithms for FIR Transversal Filtering” by George-Othon Glentis et al., IEEE Signal Processing Magazine, Vol. 16, No. 4, July 1999, pp. 13-41.

It should be noted that equation 5 (supra) requires two multiplication operations per weight which is relatively time-consuming and leads to complexity. The adaptive filter 34 of the above-described embodiment of the invention uses a different approach which is simpler since, as can be seen from FIG. 3, it requires only a shift register 62 and a two's complement circuit 64. The weighting coefficient value is derived as follows:

$${W}_{j + 1} = {W}_{j} + \{ \begin{matrix}\frac{{ε}_{j}}{{2}^{- n}} \text{if} sgn ( {X}_{j} ) = + ve \\ - \frac{{ε}_{j}}{{2}^{- n}} \text{if} sgn ( {X}_{j} ) = - ve\end{matrix}$$

The negative value

$$- \frac{{ε}_{j}}{{2}^{- n}}$$

is obtained by applying 2's complement to the positive value

$$\frac{{ε}_{j}}{{2}^{- n}} ,$$

i.e., by means of the two's complement circuit 64 (FIG. 3).

As described above, the shift register 62 shifts the error signal εⱼ right by a number of bits “N”, the value of “N” being determined by the controller 56, conveniently heuristically by taking the average of the sums of the weighted signals according to equation 6. It should be noted that, because multiplication is avoided, this circuit is simple and operates more quickly.

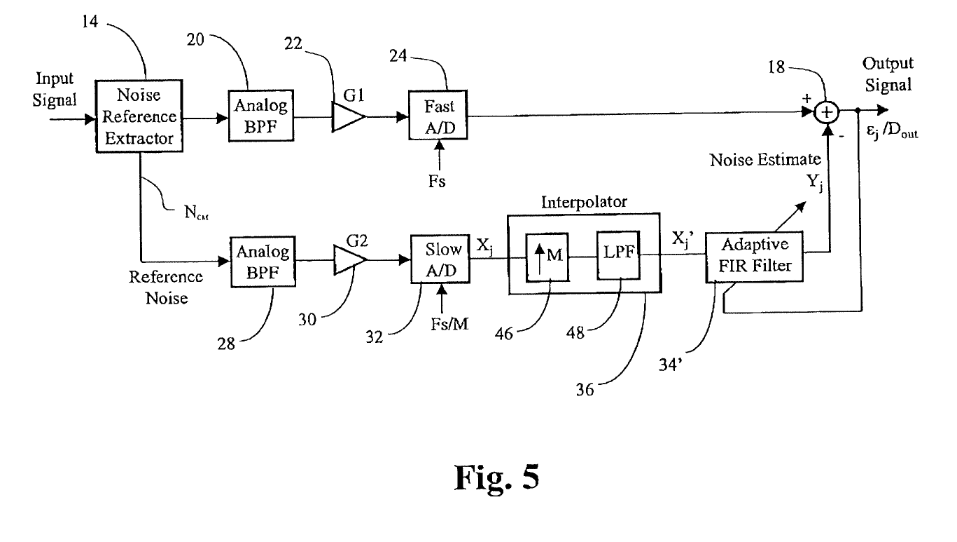

FIG. 5 illustrates a second embodiment of the invention which involves a modification to the circuit of FIG. 1 and which may be used in situations where the coefficients of the adaptive filter can be adapted at the signal sampling rate. Thus, the circuit shown in FIG. 5 is similar to that shown in FIG. 1, but the decimator 40, the summing device 38 and the delay 26 are omitted and the interpolator 36 is positioned before the adaptive filter 34′. The prime signifies that the adaptive filter 34′ may be identical in configuration to adaptive filter 34, but will differ in that it will operate more quickly. The output of the adaptive filter 34′ is supplied directly to the summing device 18. The interpolator 36 upsamples the sampled signal Xⱼ to the sampling rate of the input/differential signal Dⱼ+Nⱼ interpolating it, by filtering, and supplies the interpolated signal to the adaptive filter 34′. The output of the adaptive filter 34′ is subtracted from the digitized input signal by summing device 18 and the resulting error signal εⱼ i.e. which in this case is also the output signal Dour, is used to adjust the coefficients of the adaptive filter 34. Thus, the common mode signal is still sampled at the slower rate Fs/M, which again means that A-D converter 32 can use a slow sampling rate Fs/M and hence be less expensive and require less power.

The invention comprehends various modifications to the above-described preferred embodiments. For example, for applications which do not involve common mode noise in telephone subscriber loops, the hybrid transformer could be replaced by alternative means of extracting the reference noise signal. Moreover, if the bandwidth of the input signal is already restricted, the first bandpass filter 20 might be omitted.

Although the foregoing description relates to noise suppression circuits for a typical telecommunications receiver, it will be appreciated that the invention could be deployed in other communications systems. In fact, the invention is not limited to the suppression of interference in communications channels, but could be applied to other situations where a signal is corrupted by noise/interference, such as during storage and retrieval of an information signal.

Industrial Applicability

Embodiments of the invention permit noise such as RFI to be reduced significantly. The noise reduction in a twisted-pair cable will improve the Signal-to-Noise ratio, thereby increasing the reach of digital subscriber loop modems or allowing higher signalling rates in a loop of a particular length.

1. Noise suppression apparatus comprising:
means (14) for deriving a reference noise signal (N_{CM}) representing noise in a selected portion of a frequency spectrum of an input signal (S),
first analog-to-digital conversion means (24) for sampling the input signal at a first sampling frequency (Fₛ) to produce a digital signal (Dⱼ+Nⱼ),
second analog-to-digital conversion means (32) for sampling the reference noise signal (Non) at a lower sampling frequency (Fₛ/M) to provide a digital reference noise signal (Xⱼ) having a sample rate lower than a sample rate of the digital signal,
decimation means (40) for decimating the digital signal (Dⱼ+Nⱼ) to produce a decimated signal (Dⱼ′+Nⱼ′ having the same sample rate as the digital reference noise signal (Xⱼ),
adaptive filter means (34) having adjustable coefficients (W) for filtering the digital reference noise signal (Xⱼ) to provide a noise estimate signal (Y′ⱼ)
means (38) for subtracting the noise estimate signal (Y′ⱼ) from the decimated digital signal (Dⱼ′+Nⱼ′) to provide an error signal (εⱼ), the adaptive filter means (34) using the error signal (εⱼ) to adjust the coefficients of the adaptive filter for the next sample,
interpolation means (46) for upsampling and interpolating the noise estimate signal (Y′ⱼ) to restore the noise estimate signal to the same sample rate as the digital signal (Dⱼ′+Nⱼ′),
means (18) for subtracting the restored noise estimate signal (Yⱼ) from the digital signal (Dⱼ+Nⱼ) to provide a noise-suppressed output signal (D_{OUT}), and
delay means (26) for synchronizing the digital signal and the restored noise estimate signal as applied to the second subtracting means.

2. Apparatus according to claim 1, wherein the decimation ratio is equal to the ratio between the first and second sampling frequencies.

3. Apparatus according to claim 1, wherein the means for deriving a reference noise signal comprises a hybrid device for extracting a common mode reference noise signal from a communications channel.

4. Apparatus according to claim 2, wherein the means for deriving a reference noise signal comprises a hybrid device for extracting a common mode reference noise signal from a communications channel.

5. A method of suppressing noise in an input signal comprising the steps of:
(i) deriving a reference noise signal representing noise in a selected portion of a frequency spectrum of the input signal,
(ii) converting the input signal to a digital signal by sampling the input signal at a first sampling rate (FP),
(iii) sampling the reference noise signal at a lower sampling frequency (Fₛ/M) to provide a digital reference noise signal that having a sample rate lower than a sample rate of the digital signal,
(iv) decimating the digital signal to produce a decimated signal having the same sample rate as the digital reference noise signal,
(v) using an adaptive filter means having adjustable coefficients, filtering the digital reference noise signal to provide a noise estimate signal,
(vi) subtracting the noise estimate signal from the decimated signal to provide an error signal,
(vii) using the error signal to adjust the coefficients of the adaptive filter for a next sample,
(viii) upsampling and interpolating the noise estimate signal to restore the noise estimate signal to the same sample rate as the digital signal,
(ix) synchronizing the digital signal and the restored noise estimate signal, and
(x) subtracting the restored noise estimate signal from the digital signal to provide a noisesuppressed output signal.

6. A method according to claim 5, wherein the decimation ratio is equal to the ratio between the first and second sampling frequencies.

7. A method according to claim 5, wherein the step of deriving a reference noise signal uses a hybrid device to extract a common mode reference noise signal from a communications channel.

8. A method according to claim 6, wherein the step of deriving a reference noise signal uses a hybrid device to extract a common mode reference noise signal from a communications channel.

9. Noise suppression apparatus comprising:
means (14) for deriving a reference noise signal (N_{CM}) representing noise in a selected portion of a frequency spectrum of an input signal (S),
first analog-to-digital conversion means (24) for sampling the input signal at a first sampling frequency (Fₛ) to produce a digital signal (Dⱼ+Nⱼ),
second analog-to-digital conversion means (32) for sampling the reference noise signal (N_{CM}) at a lower sampling frequency (Fₛ/M) to provide a digital reference noise signal (Xⱼ) having a sample rate lower than a sample rate of the digital signal,
interpolation means (46) for upsampling and interpolating the digital reference noise signal (Y′ⱼ) to the same sample rate as the digital signal (D′ⱼ+N′ⱼ),
adaptive filter means (34) having adjustable coefficients (W) for filtering the interpolated digital reference noise signal (Xⱼ′) to provide a noise estimate signal (Yⱼ′), and
means (18) for subtracting the noise estimate signal (Yⱼ) from the digital signal (Dⱼ+Nⱼ) to provide a noise-suppressed output signal (D_{OUT}), and supplying the noise-suppressed output signal (D_{OUT}) to the adaptive filter for use in updating weighting coefficients thereof for use with the next sample.

10. A method of suppressing noise in an input signal comprising the steps of:
(i) deriving a reference noise signal representing noise in a selected portion of a frequency spectrum of the input signal,
(ii) converting the input signal to a digital signal by sampling the input signal at a first sampling frequency (Fₛ),
(iii) sampling the reference noise signal at a lower sampling frequency (Fₛ/M) to provide a digital reference noise signal having a sample rate lower than a symbol rate of the digital signal,
(iv) upsampling and interpolating the noise estimate signal to the same sampling rate as the digital signal,
(v) using an adaptive filter means having adjustable coefficients, filtering the interpolated digital reference noise signal to provide a noise estimate signal,
(vi) subtracting the noise estimate signal from the decimated signal to provide a noise-suppressed signal, and
(vii) using the noise-suppressed signal to adjust the coefficients of the adaptive filter for the next sample.
